(19) United States
(12) Patent Application Publication
(10) Pub. No.: US 2020/0290056 A1
(43) Pub. Date: Sep. 17, 2020

(54) ENERGY-SAVING AUTO FEED SHREDDER

(71) Applicant: Michilin Prosperity Co., Ltd., New Taipei City (TW)

(72) Inventor: Tie-Chun WANG, New Taipei City (TW)

(73) Assignee: MICHILIN PROSPERITY CO., LTD.

(21) Appl. No.: 16/354,466

(22) Filed: Mar. 15, 2019

(51) Int. Cl. B02C 18/22; B02C 18/00

(52) U.S. Cl. CPC B02C 18/2283; B02C 18/0007

(57) ABSTRACT

An energy-saving auto feed shredder which includes an operable cover as configured in a conventional auto feed shredder, with a pressing device configured on the cover. Once the cover is open, other components are exposed, such as a feeder base or compartment to place the stack of paper, a feeder slot in the middle of the feeder base or compartment, feeding mechanisms on both sides of the feeder slot, and a shredder mechanism below the feeder slot; when the cover is closed, the pressing device applies a pressure on the stack of paper inside the feeder base, and the feeding mechanisms in relative motion on both sides of the feeder slot captures and pulls the sheet at the bottom of the stack of paper under pressure, and force it to fold toward the feeder slot, and be delivered to the shredder mechanism. Repeatedly, new sheet of paper is captured, pulled, folded and delivered by the feeding mechanism, until the whole stack of paper is shredded. Wherein, the feeder slot is in nearly parallel orientation with the folding line of the shorter side of the stack of paper placed inside the feeder base, so that the shorter side of the stack of paper can be captured, pulled, folded and delivered to the shredder mechanism by the feeding mechanism.

### FIELD OF INVENTION

The present invention relates generally to a paper shredder, and more particularly to an energy-saving auto feed shredder.

### BACKGROUND TO THE INVENTION

As known to all, in a paper shredder to shred paper, there are multiple cutting blades and spacers installed on two parallel rotary shafts in relative motion. The rotary shafts are driven by a motor and gear box to slice the paper fed into the shredder. To prevent failure of the motor of the paper shredder due to overload, there is a preset limit for sheet capacity. That is to say, when a lot of paper needs to be destroyed, the amount of paper put into the shredder each time by the user must be lower than the maximum sheet capacity. Batch-by-batch manual feeding of the paper into the shredder is boring and time-wasting. Therefore, auto feed shredders with the function of automatic paper feeding are developed to meet the demand for large-quantity paper shredding.

For example, in the U.S. Pat. No. 9,884,323 Patent disclosed in FIG. 1A and FIG. 1B, when the openable cover 14 of the auto feed shredder is opened, there can be seen a feeder base or compartment 34, to hold stack of standard sized paper, and in the middle of the bottom of the feeder base or compartment 34, there is a feeder slot 28. Once there is paper passing by the feeder slot 28, the shredder mechanism 36 below the feeder slot will be activated to cut the paper into debris, which then falls into the waste bin. The bottom of the cover 14 is configured with pressure plates 32, when the cover 14 is closed, the pressure plates 32 will apply a pressure on the stack of paper placed inside the feeder base or compartment. On both sides of the feeder slot 28, there are feeding mechanisms 30 in relative rotary motion. The feeding mechanisms can be a plurality of symmetrically arranged rubber rollers, or a roller-belt assembly. When touching the bottom of the stack of paper inside the feeder base or compartment 34, the feeding mechanisms 30 in relative rotary motion will capture and pull the paper sheets at the bottom of the stack and fold them above the feeder slot 28, and then deliver them to the shredder mechanism 36 below the slot. Repeatedly, new paper sheets at the bottom of the stack are captured, pulled, folded and delivered by the feeding mechanism, until all the paper is shredded.

Auto feed shredders having similar functions as described above are also disclosed in FIG. 2, U.S. Pat. No. 7,387,268; FIG. 3, U.S. Pat. No. 7,658,342; FIG. 4, U.S. Pat. No. 8,336,794.

Referring to FIG. 5, said conventional auto feed shredders share the same characteristic that the feeder slot 28 in the middle of the feeder base or compartment 34 is in nearly parallel orientation with the folding line Py of the longer side L of the stack of paper P placed inside the feeder base or compartment 34. With such a design, the longer side L of the stack of paper P can be captured, pulled, folded and delivered by the feeding mechanism. That is to say, when passing through the shredder mechanism (not shown in the drawing), the motion range of the paper sheets captured from the bottom of the stack of paper P to be shredded is half of the longer side (½ L) of the paper to be shredded. Taking the longer side (29.7 cm) of an A4 sheet for example, the length is 14 cm or so after folding. Therefore, the time to shred an A4 paper sheet is the time for the shredder mechanism to cut ½ L i.e., 14 cm.

It can be concluded that, the time for the shredder mechanism to cut the paper sheets to be shredded has a direct proportional relationship with the motion range of the paper sheets to be shredded when passing through the shredder mechanism after folding. In another word, the shorter motion range of the folded paper sheets to be shredded passing through the shredder mechanism, the shorter time is needed to shred the paper. The accumulated results will dramatically reduce the operation time of the motor and save considerable energy.

### SUMMARY OF THE INVENTION

The main object of the present invention is to provide an energy-saving auto feed shredder, wherein, the feeder slot is in nearly parallel orientation with the folding line of the shorter side of the stack of paper placed inside the feeder base or compartment, so that the shorter side of the stack of paper can be captured, pulled, folded and delivered to the shredder mechanism by the feeding mechanism.

To accomplish the above object, the present invention provides an energy-saving auto feed shredder, which includes an openable cover as configured in a conventional auto feed shredder with a pressing device configured on the cover. Once the cover is open, other components of the present invention are exposed, such as a feeder base or compartment to place the stack of paper, a feeder slot in the middle of the feeder base or compartment, feeding mechanisms on both sides of the feeder slot, and a shredder mechanism below the feeder slot; when the cover is closed, the pressing device applies a pressure on the stack of paper inside the feeder base, and the feeding mechanisms in relative motion on both sides of the feeder slot captures and pulls the sheets at the bottom of the stack of paper under pressure, and force them to fold toward the feeder slot, and be delivered to the shredder mechanism. Repeatedly, new sheets of paper are captured, pulled, folded and delivered by the feeding mechanism, until the whole stack of paper is shredded. Wherein, the feeder slot is in nearly parallel orientation with the folding line of the shorter side of the stack of paper inside the feeder base, so that the shorter side of the stack of paper can be captured, pulled, folded and delivered to the shredder mechanism by the feeding mechanism.

As the feeder slot is intentionally designed to be in nearly parallel orientation with the folding line of the shorter side of the stack of paper placed inside the feeder base or compartment, the shorter side of the stack of paper will be captured, pulled, folded and delivered to the shredder mechanism by the feeding mechanism; Taking the shorter side (21 cm) of an A4 paper sheet as an example, the length becomes 10.5 cm after folding. Therefore, the time for shredding an A4 paper sheet is the time used by the shredder mechanism to cut the length of ½ W (namely 10.5 cm).

In a conventional auto feed shredder, the feeder slot is in nearly parallel orientation with. the folding line of the longer side of the stack of paper, so that the longer side of the stack of paper is captured, pulled, folded and delivered by the feeding mechanism; In comparison, in the present invention, the feeder slot is intentionally designed to be in nearly parallel orientation with the folding line of the shorter side of the stack of paper placed inside the feeder base or compartment, so that the shorter side of the stack of paper will be captured, pulled, folded and delivered to the shredder mechanism by the feeding mechanism; Taking an A4 paper sheet for example, the cutting range of a conventional auto feed shredder is 14 cm, while the present invention has an obviously much shorter cutting range (10.5 cm). Therefore, to shred an A4 paper sheet, the present invention will save about 25% of the time.

### BRIEF DESCRIPTION OF THE DRAWINGS

FIG. 1A, FIG. 1B are structural views of U.S. Pat. No. 9,884,323;

FIG. 2 is a structural view of U.S. Pat. No. 7,387,268;

FIG. 3 is a structural view of U.S. Pat. No. 7,658,342;

FIG. 4 is a structural view of U.S. Pat. No. 8,336,794;

FIG. 5 is a schematic view showing the folding line of the longer side of the paper sheet is in nearly parallel orientation with the feeder slot when a stack of paper is placed inside the feeder base or compartment of a conventional auto feed shredder;

FIG. 6 is a schematic view showing the folding line of the shorter side of the paper sheet is in nearly parallel orientation with the feeder slot when a stack of paper is placed inside the feeder base or compartment of the first embodiment of the present invention;

FIG. 7 is a schematic view showing the relative positions of the stack of paper and the feeder base or compartment in the first embodiment of the present invention;

FIG. 8 is a schematic view showing the relative positions of the folding line of the shorter side of the stack of paper and the feeder slot in the first embodiment of the present invention;

FIG. 9A is a schematic view showing the relative positions of the folding line of the shorter side of the stack of paper and the feeder slot in the second embodiment of the present invention;

FIG. 9B is a schematic view showing the relative positions of the folding line of the shorter side of the stack of paper and the feeder slot in the third embodiment of the present invention; and

FIG. 9C is a schematic view showing the relative positions of the folding line of the shorter side of the stack of paper and the feeder slot in the fourth embodiment of the present invention.

### DETAILED DESCRIPTION

The features of the present invention can be readily understood by referring to the drawings and detailed descriptions of preferred embodiments of the present invention.

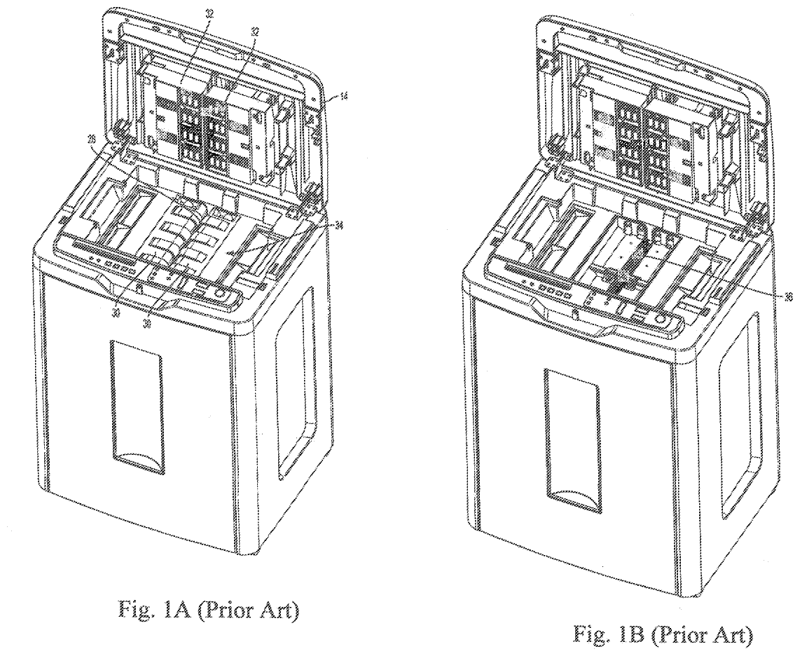

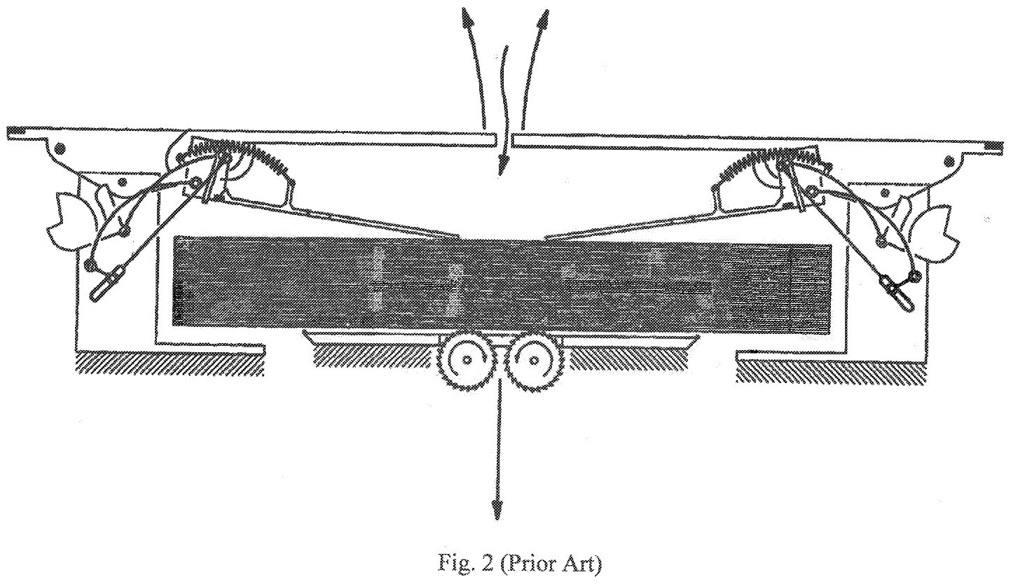

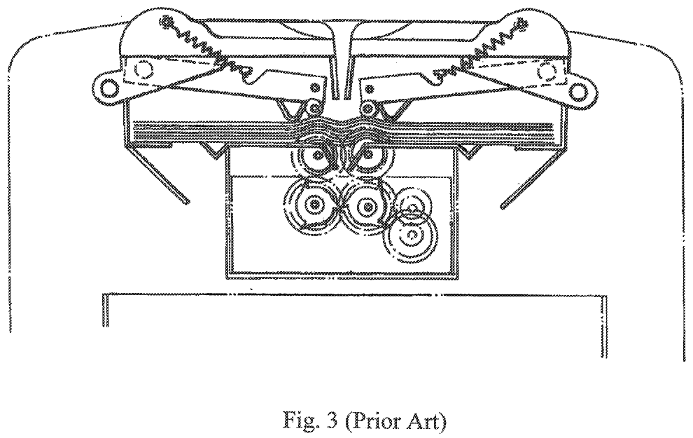

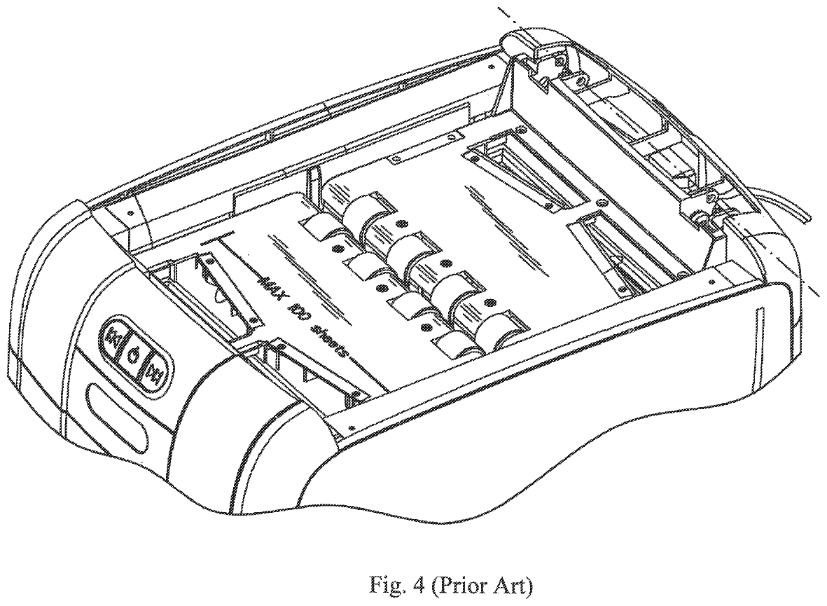

The present invention is an energy-saving auto feed shredder, which includes an openable cover 14 as configured in a conventional auto feed shredder (see FIG. 1 to FIG. 5) with a pressing device 32 configured on the cover. Once the cover 14 is open, other components of the present invention are exposed, such as a feeder base or compartment 34 to place the stack of paper, a feeder slot 28 in the middle of the feeder base or compartment 34, feeding mechanisms 30 on both sides of the feeder slot 28, and a shredder mechanism 36 below the feeder slot 28. When the cover 14 is closed, the pressing device 32 applies a pressure on the stack of paper inside the feeder base or compartment 34, and the feeding mechanisms 30 in relative motion on both sides of the feeder slot 28 captures and pulls the sheet at the bottom of the stack of paper under pressure, and force it to fold. toward the feeder slot 28, and be delivered to the shredder mechanism 36. Repeatedly, new sheet of paper are captured, pulled, folded and delivered by the feeding mechanism, until the whole stack of paper is shredded.

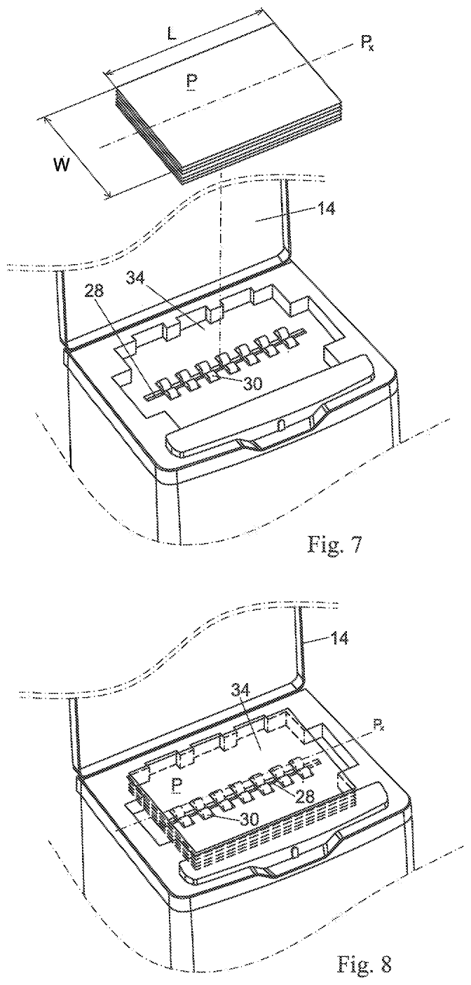

Referring to FIGS. 6-8, the feeder slot 28 is in nearly parallel orientation with the folding line Px of the shorter side W of the stack of paper P inside the feeder base or compartment 34, so that the shorter side W of the stack of paper P can he captured, folded and delivered to the shredder mechanism by the feeding mechanism.

In the present invention, the folding line Px of the shorter side W of the stack of paper P is made to be in nearly parallel orientation with the feeder slot 28, so that the shorter side W of the stack of paper P will be captured, pulled, folded and delivered to the shredder mechanism by the feeding mechanism. Taking the shorter side (21 cm) of an A4 paper sheet as an example, the length becomes 10.5 cm after folding. Therefore, the time for shredding an A4 paper sheet is the time used by the shredder mechanism to cut the length of ½ W (namely 10.5 cm).

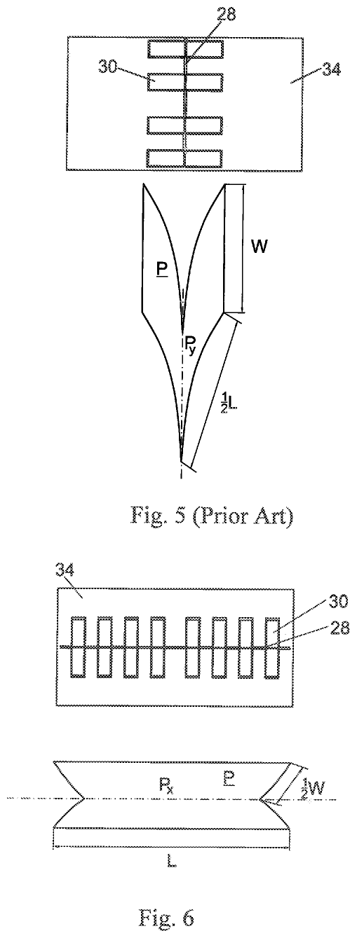

In comparison, referring to FIG. 5, in a conventional auto feed shredder, the longer side L of the stack of paper P is in nearly parallel orientation with the feeder slot 28, so that the longer side L of the stack of paper P is captured, pulled, folded and delivered by the feeding mechanism. Taking the longer side (2.9.7 cm) of an A4 paper sheet as an example, the length becomes 14 cm or so after folding. Therefore, the time for shredding an A4 paper sheet is the time used by the shredder mechanism to cut the length of ½ L (namely 14 cm or so).

In the case of an A4 paper sheet, the cutting range of a conventional auto feed shredder is 14 cm or so, while the present invention has an obviously much shorter cutting range (10.5 cm). Therefore, to shred an A4 paper sheet, the present invention will save about 25% of the time comparing to a conventional auto feed shredder.

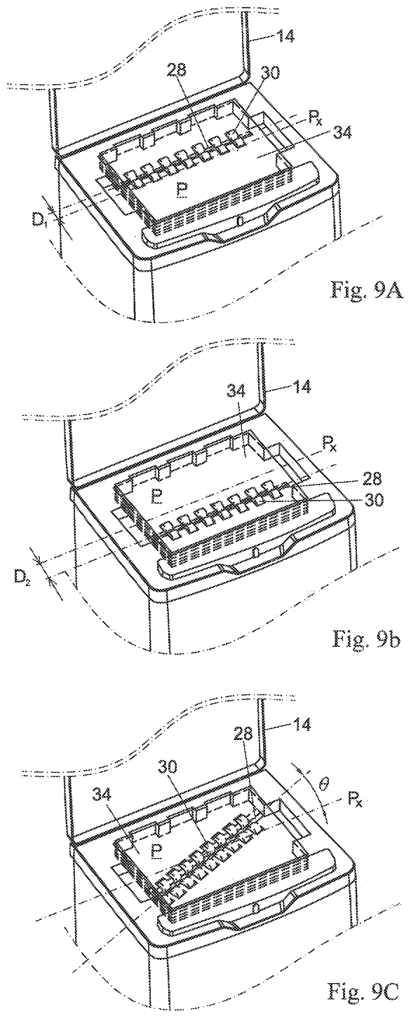

Based on the above concept and principle, slight alterations can be made to the present invention. In FIGS. 6-8, the feeder slot 28 is configured in the middle of the feeder base or compartment 34. In the second embodiment and the third embodiment disclosed in FIG. 9A and FIG. 9B, the feeder slot 28 is configured at the position with a deviation from the middle of the feeder base or compartment 34. Although the feeder base or compartment 34 has an offset distance D1, D2 from the folding line Px of the shorter side of the stack of paper, the feeder slot 28 is still in nearly parallel orientation with the folding line Px of the shorter side of the stack of paper P placed inside the feeder base or compartment 34;

FIG. 9C discloses a fourth embodiment of the present invention, wherein, the feeder slot 28 is configured with an offset angle from the middle of the feeder base or compartment 34; so that the feeder slot 28 forms an offset angle 0 with the folding line Px of the shorter side of the pressed stack of paper P placed inside the feeder base or compartment 34.

The foregoing description of the invention includes preferred embodiments thereof. Modifications may be made thereto without departing from the scope of the invention. To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. An energy-saving auto feed shredder, including an openable cover as configured in a conventional auto feed shredder, with a pressing device configured on the cover; once the cover is open, other components are exposed, such as a feeder base or compartment to place the stack of paper, a feeder slot in the middle of the feeder base or compartment, feeding mechanisms on both sides of the feeder slot, and a shredder mechanism below the feeder slot; when the cover is closed, the pressing device applies a pressure on the stack of paper inside the feeder base, and the feeding mechanisms in relative motion on both sides of the feeder slot captures and pulls the sheet at the bottom of the stack of paper under pressure, and force it to fold toward the feeder slot, and be delivered to the shredder mechanism; repeatedly, new sheet of paper is captured, pulled, folded and delivered by the feeding mechanism, until the whole stack of paper is shredded; wherein, said feeder slot is in nearly parallel orientation with the folding line of the shorter side of the stack of paper placed inside the feeder base, so that the shorter side of the stack of paper can be captured, pulled, folded and delivered to the shredder mechanism by the feeding mechanism.

2. An energy-saving auto feed shredder, including an openable cover as configured in a conventional auto feed shredder, with a pressing device configured on the cover; once the cover is open, other components are exposed, such as a feeder base or compartment to place the stack of paper, a feeder slot in the middle of the feeder base or compartment, feeding mechanisms on both sides of the feeder slot, and a shredder mechanism below the feeder slot; when the cover is closed, the pressing device applies a pressure on the stack of paper inside the feeder base, and the feeding mechanisms in relative motion on both sides of the feeder slot captures and pulls the sheet at the bottom of the stack of paper under pressure, and force it to fold toward the feeder slot; and be delivered to the shredder mechanism; repeatedly, new sheet of paper is captured, pulled, folded and delivered by the feeding mechanism, until the whole stack of paper is shredded; wherein, said feeder slot forms an offset angle with the shorter side of the pressed stack of paper inside the feeder base, so that the shorter side of the stack of paper can be captured, pulled, folded and delivered to the shredder mechanism by the feeding mechanism.
